(19) United States
(12) Patent Application Publication
(10) Pub. No.: US 2006/0127850 A1
(43) Pub. Date: Jun. 15, 2006

(54) Accurately producing a base for physical dental arch model

(76) Inventor: Huafeng Wen, Redwood City, CA (US)

Correspondence Address: MORRISON & FOERSTER LLP, 755 PAGE MILL RD, PALO ALTO, CA, 94304-1018, US

(21) Appl. No.: 11/012,924

(22) Filed: Dec. 14, 2004

(51) Int. Cl. A61C 11/00; A61C 19/00

(52) U.S. Cl. 433/213; 433/74

(57) ABSTRACT

Systems and methods are disclosed to produce a dental base having sockets for receiving physical tooth models. The method includes receiving positional information of the sockets on the base, determining a relative movement between a laser and a base plate; emitting a laser beam from the laser to the base plate, and producing a socket in the base plate by the emitted laser beam to form a dental base configured to receive the physical tooth models.

### TECHNICAL FIELD

This application generally relates to the field of dental care, and more particularly to a system and a method for manufacturing and constructing a physical dental arch model.

### CROSS-REFERENCES TO RELATED INVENTIONS

The present invention is related to concurrently filed and commonly assigned U.S. patent application, titled “A base for physical dental arch model” by Huafeng Wen, concurrently filed and commonly assigned U.S. patent application, titled “Fabricating a base compatible with physical dental tooth models” by Huafeng Wen, concurrently filed and commonly assigned U.S. patent application, titled “Producing non-interfering tooth models on a base” by Huafeng Wen, concurrently filed and commonly assigned U.S. patent application, titled “System and methods for casting physical tooth model” by Huafeng Wen, concurrently filed and commonly assigned U.S. patent application, titled “Producing a base for accurately receiving dental tooth models” by Huafeng Wen, and concurrently filed and commonly assigned U.S. patent application, titled “Producing accurate base for dental arch model” by Huafeng Wen,

The present invention is also related to commonly assigned U.S. patent application, titled “Method and apparatus for manufacturing and constructing a physical dental arch model” by Huafeng Wen, Nov. 2, 2004, commonly assigned U.S. patent application, titled “Method and apparatus for manufacturing and constructing a dental aligner” by Huafeng Wen, Nov. 2, 2004, commonly assigned U.S. patent application, titled “Producing an adjustable physical dental arch model” by Huafeng Wen, Nov. 2, 2004, and commonly assigned U.S. patent application, titled “Producing a base for physical dental arch model” by Huafeng Wen, Nov. 2, 2004. The disclosure of these related applications are incorporated herein by reference.

### BACKGROUND

Orthodontics is the practice of manipulating a patient's teeth to provide better function and appearance. In general, brackets are bonded to a patient's teeth and coupled together with an arched wire. The combination of the brackets and wire provide a force on the teeth causing them to move. Once the teeth have moved to a desired location and are held in a place for a certain period of time, the body adapts bone and tissue to maintain the teeth in the desired location. To further assist in retaining the teeth in the desired location, a patient may be fitted with a retainer.

To achieve tooth movement, orthodontists utilize their expertise to first determine a three-dimensional mental image of the patient's physical orthodontic structure and a three-dimensional mental image of a desired physical orthodontic structure for the patient, which may be assisted through the use of x-rays and/or models. Based on these mental images, the orthodontist further relies on his/her expertise to place the brackets and/or bands on the teeth and to manually bend (i.e., shape) wire, such that a force is asserted on the teeth to reposition the teeth into the desired physical orthodontic structure. As the teeth move towards the desired location, the orthodontist makes continual judgments as to the progress of the treatment, the next step in the treatment (e.g., new bend in the wire, reposition or replace brackets, is head gear required, etc.), and the success of the previous step.

In general, the orthodontist makes manual adjustments to the wire and/or replaces or repositions brackets based on his or her expert opinion. Unfortunately, in the oral environment, it is impossible for a human being to accurately develop a visual three-dimensional image of an orthodontic structure due to the limitations of human sight and the physical structure of a human mouth. In addition, it is humanly impossible to accurately estimate three-dimensional wire bends (with an accuracy within a few degrees) and to manually apply such bends to a wire. Further, it is humanly impossible to determine an ideal bracket location to achieve the desired orthodontic structure based on the mental images. It is also extremely difficult to manually place brackets in what is estimated to be the ideal location. Accordingly, orthodontic treatment is an iterative process requiring multiple wire changes, with the process success and speed being very much dependent on the orthodontist's motor skills and diagnostic expertise. As a result of multiple wire changes, patient discomfort is increased as well as the cost. As one would expect, the quality of care varies greatly from orthodontist to orthodontist as does the time to treat a patient.

As described, the practice of orthodontic is very much an art, relying on the expert opinions and judgments of the orthodontist. In an effort to shift the practice of orthodontic from an art to a science, many innovations have been developed. For example, U.S. Pat. No. 5,518,397 issued to Andreiko, et. al. provides a method of forming an orthodontic brace. Such a method includes obtaining a model of the teeth of a patient's mouth and a prescription of desired positioning of such teeth. The contour of the teeth of the patient's mouth is determined, from the model. Calculations of the contour and the desired positioning of the patient's teeth are then made to determine the geometry (e.g., grooves or slots) to be provided. Custom brackets including a special geometry are then created for receiving an arch wire to form an orthodontic brace system. Such geometry is intended to provide for the disposition of the arched wire on the bracket in a progressive curvature in a horizontal plane and a substantially linear configuration in a vertical plane. The geometry of the brackets is altered, (e.g., by cutting grooves into the brackets at individual positions and angles and with particular depth) in accordance with such calculations of the bracket geometry. In such a system, the brackets are customized to provide three-dimensional movement of the teeth, once the wire, which has a two dimensional shape (i.e., linear shape in the vertical plane and curvature in the horizontal plane), is applied to the brackets.

Other innovations relating to bracket and bracket placements have also been patented. For example, such patent innovations are disclosed in U.S. Pat. No. 5,618,716 entitled “Orthodontic Bracket and Ligature” a method of ligating arch wires to brackets, U.S. Pat. No. 5,011,405 “Entitled Method for Determining Orthodontic Bracket Placement,” U.S. Pat. No. 5,395,238 entitled “Method of Forming Orthodontic Brace,” and U.S. Pat. No. 5,533,895 entitled “Orthodontic Appliance and Group Standardize Brackets therefore and methods of making, assembling and using appliance to straighten teeth”.

Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, describe methods for manipulating digital images of teeth for designing orthodontic appliances.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the arch is described in U.S. Pat. Nos. 5,342,202 and 5,340,309.

Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

The key to efficiency in treatment and maximum quality in results is a realistic simulation of the treatment process. Today's orthodontists have the possibility of taking plaster models of the upper and lower arch, cutting the model into single tooth models and sticking these tooth models into a wax bed, lining them up in the desired position, the so-called set-up. This approach allows for reaching a perfect occlusion without any guessing. The next step is to bond a bracket at every tooth model. This would tell the orthodontist the geometry of the wire to run through the bracket slots to receive exactly this result. The next step involves the transfer of the bracket position to the original malocclusion model. To make sure that the brackets will be bonded at exactly this position at the real patient's teeth, small templates for every tooth would have to be fabricated that fit over the bracket and a relevant part of the tooth and allow for reliable placement of the bracket on the patient's teeth. To increase efficiency of the bonding process, another option would be to place each single bracket onto a model of the malocclusion and then fabricate one single transfer tray per arch that covers all brackets and relevant portions of every tooth. Using such a transfer tray guarantees a very quick and yet precise bonding using indirect bonding.

U.S. Pat. No. 5,431,562 to Andreiko et al. describes a computerized, appliance-driven approach to orthodontics. In this method, first certain shape information of teeth is acquired. A uniplanar target arcform is calculated from the shape information. The shape of customized bracket slots, the bracket base, and the shape of the orthodontic archwire, are calculated in accordance with a mathematically-derived target archform. The goal of the Andreiko et al. method is to give more predictability, standardization, and certainty to orthodontics by replacing the human element in orthodontic appliance design with a deterministic, mathematical computation of a target archform and appliance design. Hence the '562 patent teaches away from an interactive, computer-based system in which the orthodontist remains fully involved in patient diagnosis, appliance design, and treatment planning and monitoring.

More recently, Align Technologies began offering transparent, removable aligning devices as a new treatment modality in orthodontics. In this system, an impression model of the dentition of the patient is obtained by the orthodontist and shipped to a remote appliance manufacturing center, where it is scanned with a CT scanner. A computer model of the dentition in a target situation is generated at the appliance manufacturing center and made available for viewing to the orthodontist over the Internet. The orthodontist indicates changes they wish to make to individual tooth positions. Later, another virtual model is provided over the Internet and the orthodontist reviews the revised model, and indicates any further changes. After several such iterations, the target situation is agreed upon. A series of removable aligning devices or shells are manufactured and delivered to the orthodontist. The shells, in theory, will move the patient's teeth to the desired or target position.

U.S. Pat. No. 6,699,037 Align Technologies describes an improved methods and systems for repositioning teeth from an initial tooth arrangement to a final tooth arrangement. Repositioning is accomplished with a system comprising a series of appliances configured to receive the teeth in a cavity and incrementally reposition individual teeth in a series of at least three successive steps, usually including at least four successive steps, often including at least ten steps, sometimes including at least twenty-five steps, and occasionally including forty or more steps. Most often, the methods and systems will reposition teeth in from ten to twenty-five successive steps, although complex cases involving many of the patient's teeth may take forty or more steps. The successive use of a number of such appliances permits each appliance to be configured to move individual teeth in small increments, typically less than 2 mm, preferably less than 1 mm, and more preferably less than 0.5 mm. These limits refer to the maximum linear translation of any point on a tooth as a result of using a single appliance. The movements provided by successive appliances, of course, will usually not be the same for any particular tooth. Thus, one point on a tooth may be moved by a particular distance as a result of the use of one appliance and thereafter moved by a different distance and/or in a different direction by a later appliance.

The individual appliances will preferably include a polymeric shell having the teeth-receiving cavity formed therein, typically by molding as described below. Each individual appliance will be configured so that its tooth-receiving cavity has a geometry corresponding to an intermediate or end tooth arrangement intended for that appliance. That is, when an appliance is first worn by the patient, certain of the teeth will be misaligned relative to an undeformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step.

The fabrication of aligners by Align Technologies utilizes stereo lithography process as disclosed in U.S. Pat. Nos. 6,471,511 and 6,682,346. Several drawbacks exist however with the stereo lithography process. The materials used by stereo lithography process may be toxic and harmful to human health. Stereo lithography process builds the aligner mold layer by layer causing the resulting aligners to have a stairmaster like spacing between the layers and such spacing has a tendency house germs and bacteria while it is worn by a patient. Furthermore, stereo lithography process used by Align Technology also requires a different aligner mold at each stage of the treatment, which produces waste and is environmental unfriendly.

The practice of orthodontics and other dental treatments including preparation of a denture can benefit from a physical dental arch model that is representative of the dentition and the alveolar ridge of a patient to be orthodontically treated. The physical dental arch model, also referred as a physical dental arch model, is often prepared based on an impression model. The physical dental arch model is generally prepared by cutting and arranging individual teeth on the alveolar ridge of the impression model. With this physical dental arch model so prepared, not only is a final goal for the dental treatment made clear, but also the occlusal condition between the maxillary and the mandibular dentitions can be ascertained specifically.

Also, the patient when the physical dental arch model is presented can visually ascertain the possible final result of orthodontic treatment he or she will receive and, therefore, the physical dental arch model is a convenient tool in terms of psychological aspects of the patient.

Making a model for a whole or a large portion of an arch is much more difficult than making one tooth abutment for implant purposes. Single teeth do not have the kind of concavities and complexities as in the inter-proximal areas of teeth in an arch. Some prior art making the physical dental arch model is carried out manually, involving not only a substantial amount of labor required, but also a substantial amount of time. It is also extremely difficult to machine an accurate arch model because of the various complex shapes and the complex features such as inter-proximal areas, wedges between teeth, etc. in an arch. There is therefore a long felt need for a practical, effective and efficient method to produce a physical dental arch model.

### SUMMARY OF THE INVENTION

The present invention has been devised to provide a practical, effective and efficient methods and apparatus to manufacture and construct the physical dental arch model.

In one aspect, the present invention relates to a method for producing a dental base having sockets for receiving physical tooth models, comprising:

receiving positional information of the sockets on the base; causing relative movement between a laser and a base plate;

emitting a laser beam from the laser to the base plate; and

producing a socket in the base plate by the emitted laser beam to form a dental base for receiving the physical tooth models.

In another aspect, the present invention relates to a method for producing a dental base having sockets for receiving physical tooth models, comprising:

producing the physical tooth models having one or more of a pin, a protrusion, and a pluggable feature at the bottom portion;

causing relative movement between a laser and a base plate;

emitting a laser beam from the laser to the base plate;

producing a socket in the base plate by the emitted laser beam; and

inserting the pin, the protrusion, or the pluggable feature at the bottom portion of the physical tooth models to the sockets in the base to form a physical dental arch model.

In yet another aspect, the present invention relates to a system for producing a base for receiving physical tooth models, comprising:

a computer adapted to store positional information of the sockets to be formed on a base plate;

a transport system configured to move the base under the control of the computer; and

a laser configured to emit a laser beam onto the base plate to form a socket in the base plate after the base plate is moved to a position in accordance to the positional information stored in the computer.

Implementations of the system may include one or more of the following. The base plate can include a material selected from the group consisting of polymers, thermal elastic materials, urethane, epoxy, plaster, clay, acrylic, latex, dental PVS, resin, metal, aluminum, ice, wax, sand, and stone. The method can further include labeling the physical tooth models in a predetermined sequence that defines the positions of the physical tooth models on the base. The method can further include generating the positional information of the sockets on the base in accordance with a digital arch models. The method can further include scanning and digitizing a patient arch to produce the digital arch model. The method can further include moving the base plate by a motorized stage in X and Y directions. The method can further include moving the base plate in a first direction and moving the laser beam in a second direction. The method can further include focusing the emitted laser beam to a location on the base plate to produce the socket. The method can further include guiding the emitted laser beam by an optical fiber to a location on the base plate to cut the socket. The material around the location on the base plate can be removed by heating, melting, or evaporation by the emitted laser beam. The physical tooth models can include features to assist the reception of the physical tooth models by the base, wherein the features can include one or more of a pin, a registration slot, a notch, a protrusion, a hole, an interlocking mechanism, a jig, and a pluggable or attachable feature. The features in the physical tooth models can be shaped in accordance with the profile of the emitted laser beam that produces the socket in the base plate. The method can further include producing a plurality of sockets in the base plate by the emitted laser beam to form a base to receive a plurality of physical tooth models to form a physical dental arch model. The base can include a plurality of configurations of sockets, wherein each of the configurations is adapted to receive physical tooth models to form a different arrangement of a tooth arch model. The method can further include inserting the physical tooth models into the sockets in a first configuration and inserting the physical tooth models into the sockets in a second configuration.

Implementations of the system may include one or more of the following. The positional information of the sockets can be derived from a digital arch model. The transport system includes a motorized stage that can move the base plate in two dimensions. The physical models can include one or more of a pin, a registration a notch, a protrusion, and a pluggable or attachable feature that can be received by the sockets in the base.

Embodiments may include one or more of the following advantages. An advantage of the present invention is that a base for a dental arch model can be accurately and repeatedly produced by a laser system. The positions of the sockets can be precisely defined by a digital dental arch model that is acquired from patient's arch. The same base can support different tooth arch models having different teeth configurations. The base can include more than one set of receiving features that can receive tooth models at different positions. The reusable base further reduces cost in the dental treatment of teeth alignment.

The physical tooth models include features to allow them to be attached, plugged or locked to a base. The physical tooth models can be pre-fabricated having standard registration and attaching features for assembling. The physical tooth models can be automatically assembled onto a base by a robotic arm under computer control. The same physical tooth models can be used to form different tooth arch models having different teeth configurations. The tooth models can be reused as tooth positions are changed during a treatment process. Much of the cost of making multiple tooth arch models in orthodontic treatment is therefore eliminated.

Another advantageous feature of the disclosed system and methods is that the physical tooth models in the physical dental arch model can be easily separated, repaired or replaced, and reassembled after the assembly without the replacement of the whole arch model.

The disclosed system and methods are simple to implement. The manufacturable components can be attached to a base. The assembled physical dental arch model specifically corresponds to the patient's arch. There is no need for complex and costly mechanisms such as micro-actuators for adjusting multiple degrees of freedom for each tooth model. The described methods and system is simple to make and easy to use.

The physical dental arch model obtained by the disclosed system and methods can be used for various dental applications such as dental crown, dental bridge, aligner fabrication, biometrics, and teeth whitening. The arch model can be assembled from segmented manufacturable components that can be individually manufactured by automated, precise numerical manufacturing techniques.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

The accompanying drawing, which are incorporated in and form a part of this specification, illustrate embodiments of the invention and, together with the description, serve to explain the principles of the invention:

FIG. 1 is a flow chart for producing a physical dental arch model in accordance with the present invention.

FIG. 2 illustrates a tooth model and a base respectively comprising complimentary features for assembling the tooth model with the base.

FIG. 3 illustrates fixing a stud to a tooth model comprising a female socket to produce a tooth model having a protruded stud.

FIG. 4 illustrate a tooth model comprising two pins that allow the tooth model to be plugged into two corresponding holes in a base.

FIG. 5 illustrate a tooth model comprising a protruded pin that allows the tooth model to be plugged into a hole in a base.

FIG. 6 illustrates cone shaped studs protruded out of the bottom of a tooth model.

FIG. 7 illustrates exemplified shapes for the studs at the bottom of a tooth model.

FIG. 8A illustrates an example of a base comprising a plurality of female sockets for receiving a plurality of tooth models for forming a physical dental arch model.

FIG. 8B illustrates another example of a base comprising a plurality of female sockets for receiving a plurality of tooth models for forming a physical dental arch model.

FIG. 9 illustrates a tooth model that can be assembled to the base in FIGS. 8A and 8B.

FIG. 10 illustrates a laser cutting system for fabricating features in a dental base for receiving tooth models.

FIG. 11 illustrates a base comprising multiple sets of sockets for receiving a plurality of dental arches in different configurations.

### DESCRIPTION OF INVENTION

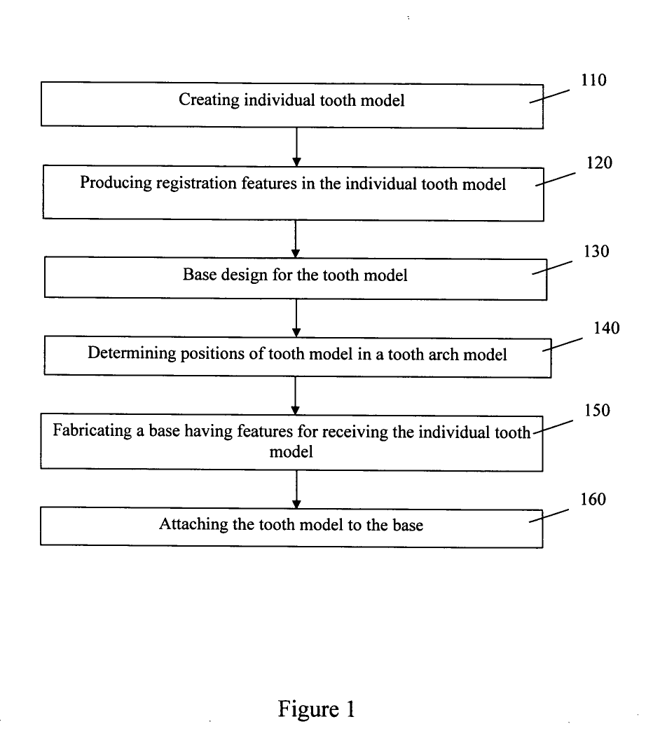

Major operations in producing a physical dental arch model are illustrated in FIG. 1. The process generally includes the following operations. First individual tooth model is created in step 110. An individual tooth model is a physical model that can be part of a physical tooth arch model, which can be used in various dental applications. Registration features are next added to the individual tooth model to allow them to be attached to each other or a base in step 120. A base is designed for receiving the tooth model in step 130. The tooth model positions in a tooth arch model are next determined in step 140. A base is fabricated in step 150 using laser based technologies. The base includes features for receiving the individual tooth model. The tooth models are finally attached to the base at the predetermined positions using the pre-designed features in step 160.

Details of process in FIG. 1 are now described. Individual tooth model can be obtained in step 110 in a number of different methods. The tooth model can be created by casting. A negative impression is first made from a patient's arch using for example PVS. A positive of the patient's arch is next made by pouring a casting material into the negative impression. After the material is dried, the mould is then taken out with the help of the impression knife. A positive of the arch is thus obtained.

In an alternative approach, the negative impression of the patient's arch is placed in a specially designed container. A casting material is then poured into the container over the impression to create a model. A lid is subsequently placed over the container. The container is opened and the mould can be removed after the specified time.

Examples of casting materials include auto polymerizing acrylic resin, thermoplastic resin, light-polymerized acrylic resins, polymerizing silicone, polyether, plaster, epoxies, or a mixture of materials. The casting material is selected based on the uses of the cast. The material should be easy for cutting to obtain individual tooth model. Additionally, the material needs to be strong enough for the tooth model to take the pressure in pressure form for producing a dental aligner. Details of making a dental aligner are disclosed in commonly assigned and above referenced U.S. patent application titled “Method and apparatus for manufacturing and constructing a dental aligner” by Huafeng Wen, filed Nov. 2, 2004, the content of which is incorporated herein by reference.

Features that can allow tooth models to be attached to a base (step 120) can be added to the casting material in the casting process. Registration points or pins can be added to each tooth before the casting material is dried. Optionally, universal joints can be inserted at the top of the casting chamber using specially designed lids, which would hang the universal joints directly into the casting area for each tooth.

Still in step 110, individual tooth models are next cut from the arch positive. One requirement for cutting is to obtain individual teeth in such a manner that they can be joined again to form a tooth arch. The separation of individual teeth from the mould can be achieved using a number of different cutting methods including laser cutting and mechanical sawing.

Separating the positive mould of the arch into tooth models may result in the loss of the relative 3D coordinates of the individual tooth models in an arch. Several methods are provided in step 120 for finding relative position of the tooth models. In one embodiment, unique registration features are added to each pair of tooth models before the positive arch mould is separated. The separated tooth models can be assembled to form a physical dental arch model by matching tooth models having the same unique registration marks.

The positive arch mould can also be digitized by a three-dimensional scanning using a technique such as laser scanning, optical scanning, destructive scanning, CT scanning and Sound Wave Scanning. A physical digital arch model is therefore obtained. The physical digital arch model is subsequently smoothened and segmented. Each segment can be physically fabricated by CNC based manufacturing to obtain individual tooth models. The physical digital arch model tracks and stores the positions of the individual tooth models. Unique registration marks can be added to the digital tooth models that can be made into a physical feature in CNC base manufacturing.

Examples of CNC based manufacturing include CNC based milling, Stereolithography, Laminated Object Manufacturing, Selective Laser Sintering, Fused Deposition Modeling, Solid Ground Curing, and 3D ink jet printing. Details of fabricating tooth models are disclosed in commonly assigned and above referenced U.S. patent application titled “Method and apparatus for manufacturing and constructing a physical dental arch mode” by Huafeng Wen, filed Nov. 2, 2004, the content of which is incorporated herein by reference.

In another embodiment, the separated tooth models are assembled by geometry matching. The intact positive arch impression is first scanned to obtain a 3D physical digital arch model. Individual teeth are then scanned to obtain digital tooth models for individual teeth. The digital tooth models can be matched using rigid body transformations to match a physical digital arch model. Due to complex shape of the arch, inter-proximal areas, root of the teeth and gingival areas may be ignored in the geometry match. High precision is required for matching features such as cusps, points, crevasses, the front faces and back faces of the teeth. Each tooth is sequentially matched to result in rigid body transformations corresponding to the tooth positions that can reconstruct an arch.

In another embodiment, the separated tooth models are assembled and registered with the assistance of a 3D point picking devices. The coordinates of the tooth models are picked up by 3D point picking devices such as stylus or Microscribe devices before separation. Unique registration marks can be added on each tooth model in an arch before separation. The tooth models and the registration marks can be labeled by unique IDs. The tooth arch can later be assembled by identifying tooth models having the same registration marks as were picked from the Jaw. 3D point picking devices can be used to pick the same points again for each tooth model to confirm the tooth coordinates.

The base is designed in step 130 to receive the tooth models. The base and tooth models include complimentary features to allow them to be assembled together. The tooth model has a protruding structure attached to it. The features at the base and tooth models can also include a registration slot, a notch, a protrusion, a hole, an interlocking mechanism, and a jig. The protruding structure can be obtained during the casting process or be created after casting by using a CNC machine on each tooth. The positions of the receiving features in the base are determined by either the initial positions of the teeth in an arch or the desired teeth positions during a treatment process (step 140).

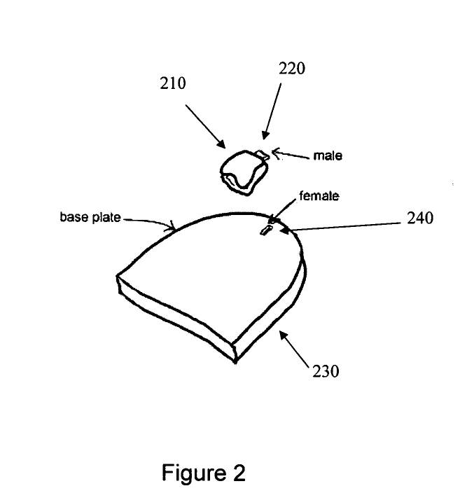

Before casting the arch from the impression, female structures can be produced in the base plate receiving individual tooth (step 150). Then the base is placed over the casting container in which the impression is already present and the container is filled with epoxy. The epoxy gets filled up in the female structures and the resulting mould has the male studs present with each tooth model that can be separated afterwards. FIG. 2 shows a tooth model 210 with male stud 220 after mould separation. The base 230 includes a female feature 240 that can receive the male stud 220 when the tooth model 210 is assembled to the base 230.

The female features 240 in the base 230 can be sockets for receiving the tooth models. In accordance with the present invention, the sockets in the base can be produced by laser based fabrication technologies. Laser is used to heat, melt and even vaporize the base material. A laser beam can be focused precisely at the locations of the sockets. The intensity and duration of the laser beam can be controlled.

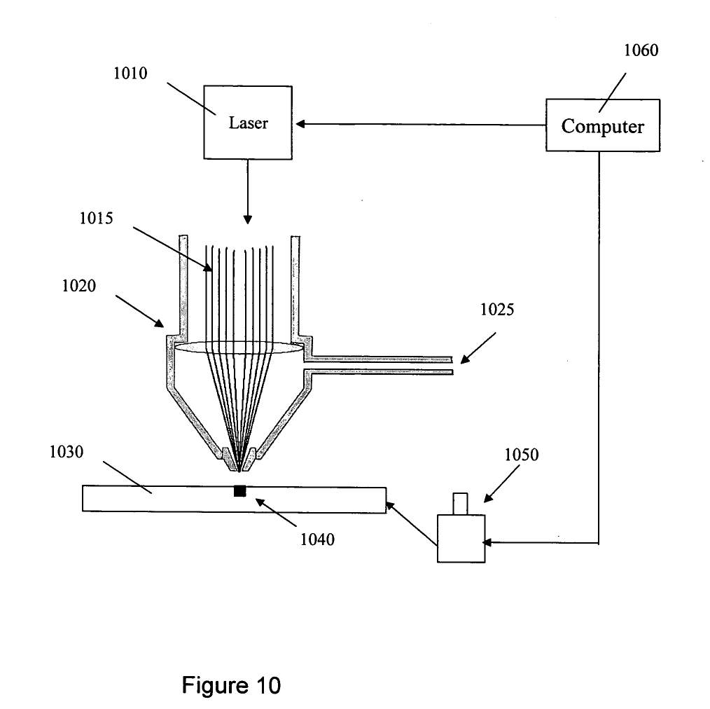

As shown in FIG. 10, the laser 1010 can be a carbon dioxide laser under CNC control. The laser beam 1015 is focused on a base plate 1030 by an optical system 1020 comprising a pressurized gas inlet 1025. The cutting process can be automated by a computer 1060. The base plate 1030 can be transported by a transport system 1050 such as a motorized X-Y stage under the control of computer 1060. The coordinates of the female sockets 1040 are input to the CNC machine. The coordinate information can be derived from the digital dental arch model as previously described.

The base plate 1030 is moved to position so the laser beam can be focused at the intended locations where the socket is to be made. A laser beam is emitted under the control of the computer 1060 and focused at the intended location. The laser beam 1015 heats the illuminated area on the base plate to cause heating, melting, abalation, and/or evaporation of the base plate material. The socket 1040 is cut by the laser beam under the control of the computer 1060. A microscope can be mounted for examining the result of the cutting for minor refinement. A base 230 is obtained after all the sockets are formed in the base plate 1030.

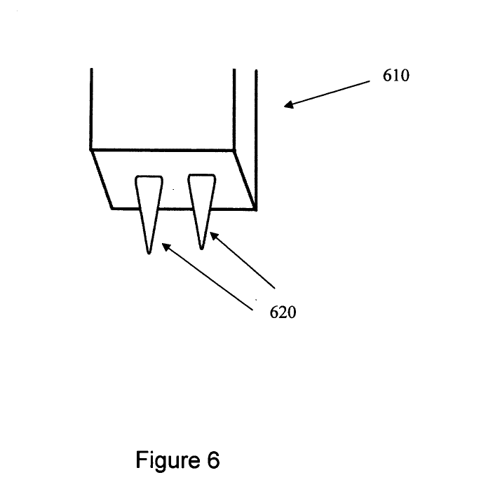

In one embodiment, the intensity and temporal duration of the emitted laser beam 1015 are controlled according to the properties of the base plate 1030 so that the socket 1015 can be produced accurately in width, depth and shape. In another embodiment, the pins in the under side of the physical tooth models are shaped in accordance with the spatial profile of the emitted laser beam 1015. This ensures the pins affixed to the tooth models are compatible and fit to the sockets 1040 since the socket 1040 is formed and profiled by the emitted beam 1015. For example, the emitted laser beam 1015 sometimes produces a cone shaped socket in the base plate 1030. The tooth model 610 can include cone shaped studs 620 as shown in FIG. 6.

In another embodiment, a plurality of laser beams can be used to cut the socket 1040. Different laser beam may include different intensity, frequencies, spatial profiles, and directions of illumination. For example, one laser may be used to burn a large hole and another laser may be used to cut fine features to the final shape of the socket.

Laser cutting offers high quality cuts which does not need any finishing. Laser cutting has the advantage of being non-contact to the base. Laser cutting can also be compatible with almost all the materials used for the dental base.

The laser optics can include other arrangements. A ‘flying optics’ system includes mirrors that can scan the laser beam across a stationary base in two dimensions. A ‘fixed optic’ system keeps the laser head remains stationary and the work piece is moved in both X and Y axes, as shown in FIG. 10. A ‘hybrid’ system moves the laser head in one axis and the base in the other axis.

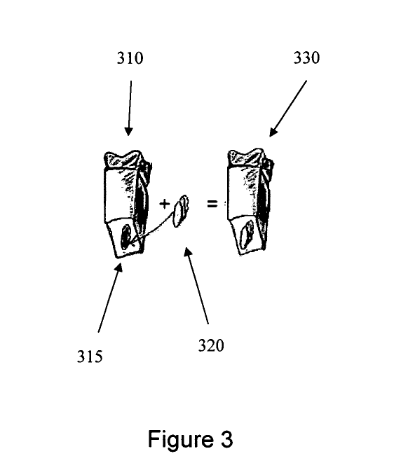

In another embodiment, as shown in FIG. 3, one or more female socket 315 can be drilled by CNC based machining on underside of the tooth model 310 after casting and separation. A male stud 320 that fits the female socket 315 can be attached to the tooth model 310 by for example, screwing, glue application, etc. The resulted tooth model 330 includes male stud 310 that allows it to be attached to the base.

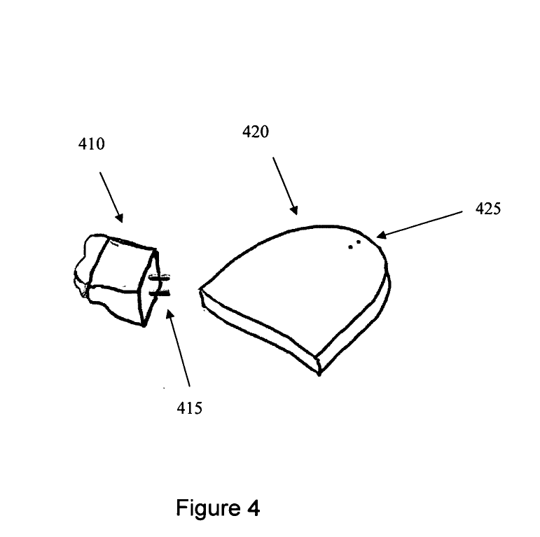

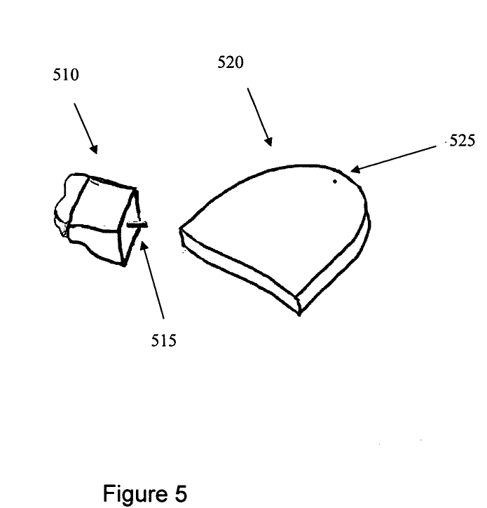

Male protrusion features over the tooth model can exist in a number of arrangements. FIG. 4 shows a tooth model 410 having two pins 415 sticking out and a base 420 having registration slots 425 adapted to receive the two pins 415 to allow the tooth model 410 to be attached to the base 420. FIG. 5 shows a tooth model 510 having one pins 515 protruding out and a base 520 having a hole 525 adapted to receive the pin 515 to allow the tooth model 510 to be attached to the base 520. In general, the tooth model can include two or more pins wherein the base will have complementary number of holes at the corresponding locations for each tooth model. The tooth model 610 can also include cone shaped studs 620 as shown in FIG. 6. The studs can also take a combination of configurations described above.

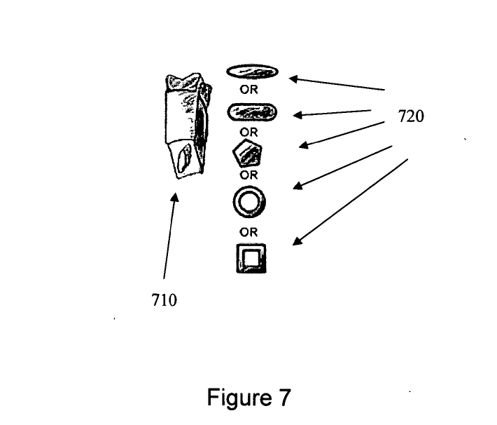

As shown FIG. 7, the studs protruding our of the tooth model 710 can take different shapes 720 such as oval, rectangle, square, triangle, circle, semi-circle, each of which correspond to slots on the base having identical shapes that can be drilled using the CNC based machining. The asymmetrically shaped studs can help to define a unique orientation for the tooth model on the base.

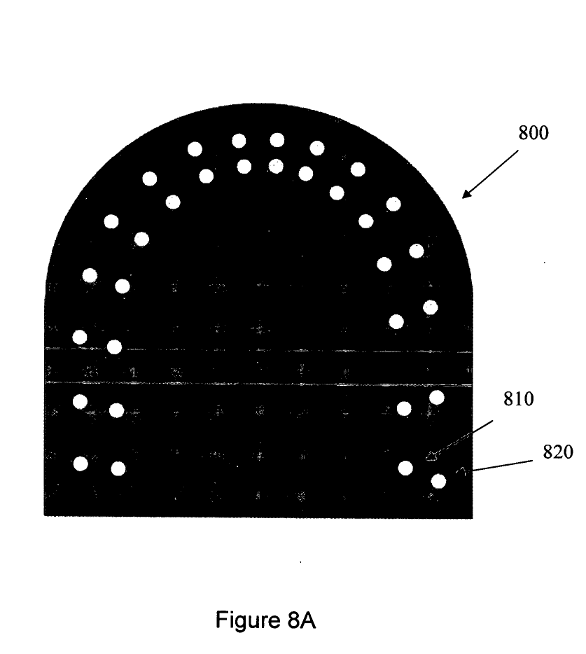

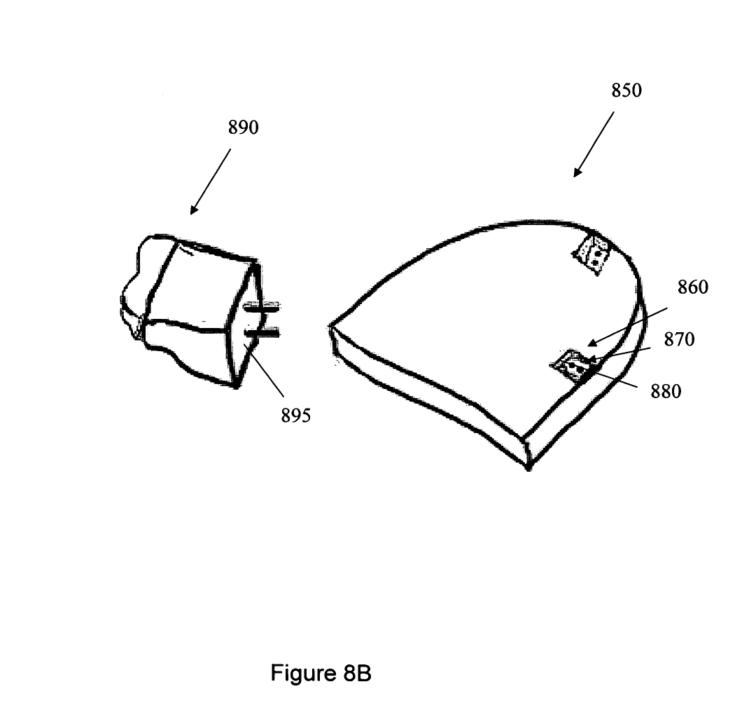

FIG. 8A shows a base 800 having a plurality of sockets 810 and 820 for receiving the studs of a plurality of tooth models. The positions of the sockets 810,820 are determined by either her initial teeth positions in a patient's arch or the teeth positions during the orthodontic treatment process. The base 800 can be in the form of a plate as shown in FIG. 8, comprising a plurality of pairs of sockets 810,820. Each pair of sockets 810,820 is adapted to receive two pins associated with a physical tooth model. Each pair of sockets includes a socket 810 on the inside of the tooth arch model and a socket 820 on the outside of the tooth arch model.

Another of a base 850 is shown in FIG. 8B. A plurality of pairs of female sockets 860, 870 are provided in the base 850. Each pair of the sockets 860, 870 is formed in a surface 880 and is adapted to receive a physical tooth model 890. The bottom portion of the physical tooth model 890 includes a surface 895. The surface 895 comes to contact with the surface 880 when the physical tooth model 890 is inserted into the base 850, which assures the stability of the physical tooth model 890 over the base 850.

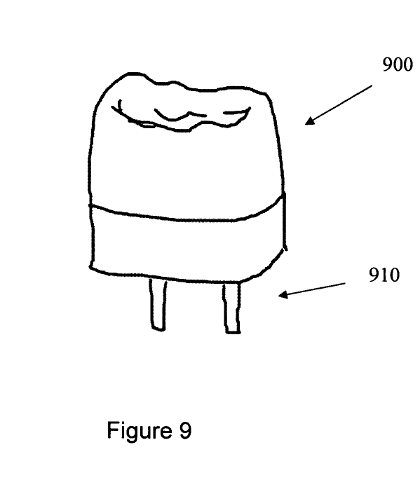

A tooth model 900 compatible with the base 800 is shown in FIG. 9. The tooth model 900 includes two pins 910 connected to its bottom portion. The two pins 910 can be plugged into a pair of sockets 810 and 820 on the base 800. Thus each pair of sockets 810 and 820 uniquely defines the positions of a tooth model. The orientation of the tooth model is also uniquely defined if the two pins are labeled as inside and outside, or the sockets and the pins are made asymmetric inside and outside. In general, each tooth model may include correspond to one or a plurality of studs that are to be plugged into the corresponding number of sockets. The male studs and the sockets may also take different shapes as described above.

A tooth arch model is obtained after the tooth models are assembled to the base 800 (step 160). The base 800 can include a plurality of configurations in the female sockets 810. Each of the configurations is adapted to receive the same physical tooth models to form a different arrangement of at least a portion of a tooth arch model.

The base 800 can be fabricated by a system that includes a computer device adapted to store digital tooth models representing the physical tooth models. As described above, the digital tooth model can be obtained by various scanning techniques. A computer processor can then generate a digital base model compatible with the digital tooth models. An apparatus fabricates the base using CNC based manufacturing in accordance with the digital base model. The base fabricated is adapted to receive the physical tooth models.

The physical tooth models can be labeled by a predetermined sequence that define the positions of the physical tooth models on the base 800. The labels can include a barcode, a printed symbol, hand-written symbol, a Radio Frequency Identification (RFID). The female sockets 810 can also be labeled by the parallel sequence for the physical tooth models.

In one embodiment, tooth models can be separated and repaired after the base. The tooth models can be removed, repaired or replaced, and re-assembled without the replacement of the whole arch model.

Common materials for the tooth models include polymers, urethane, epoxy, plastics, plaster, stone, clay, acrylic, metals, wood, paper, ceramics, and porcelain. The base can include a material such as polymers, urethane, epoxy, plastics, plaster, stone, clay, acrylic, metals, wood, paper, ceramics, porcelain, glass, and concrete.

The arch model can be used in different dental applications such as dental crown, dental bridge, aligner fabrication, biometrics, and teeth whitening. For aligner fabrication, for example, each stage of the teeth treatment may correspond to a unique physical dental arch model. Dental appliances such as aligners can be fabricated using different physical dental arch models one at a time as the teeth movement progresses during the treatment. At each stage of the treatment, the desirable teeth positions for the next stage are calculated. A physical dental arch model having modified teeth positions is fabricated using the process described above. A new aligner is made using the new physical dental arch model.

Each base is specific to an arch configuration. There is no need for complex and costly mechanisms such as micro-actuators for adjusting multiple degrees of freedom for each tooth model. The described methods and system is simple to make and easy to use.

The described methods and system are also economical. Different stages of the arch model can share the same tooth models. The positions for the tooth models at each stage of the orthodontic treatment can be modeled using orthodontic treatment software. Each stage of the arch model may use a separate base. Or alternatively, one base can be used in a plurality of stages of the arch models. The base may include a plurality of sets of receptive positions for the tooth models. Each set corresponds to one treatment stage. The tooth models can be reused through the treatment process. Much of the cost of making multiple tooth arch models in orthodontic treatment is therefore eliminated.

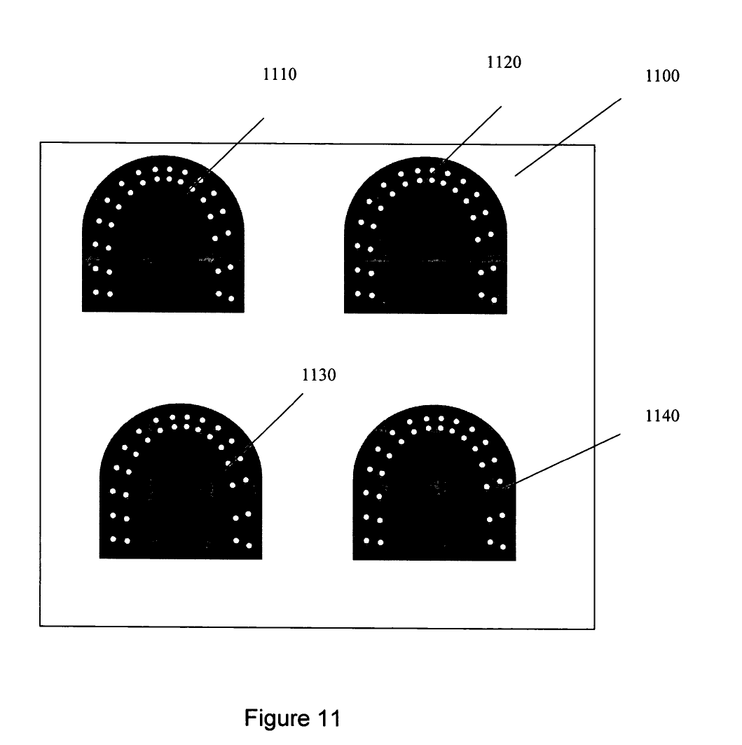

FIG. 11 a base 1100 comprising multiple sets of sockets 1110, 1120, 1130, 1140 each for receiving a dental arch in a different configuration. Different configurations of the base can be required during the process of an orthodontic treatment. The positions and orientations of the tooth models may differ step by step. The base can include a plurality of configurations in the sockets for the tooth models. Each configuration is adapted to receive the same physical tooth models to form a different arrangement of a tooth arch model.

The base can be assembled from a plurality of base components. The base components can include features to assist the assembly of the base components to form the base for the dental arch model. The features include one or more of a pin, a registration slot, a socket, a notch, a protrusion, a hole, an interlocking mechanism, a jig, and a pluggable or attachable feature.

An advantage of the present invention is that the base component can be individually replaced for a different base configuration without changing the base components that are not changed in the orthodontic steps.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method for producing a dental base having sockets for receiving physical tooth models, comprising:
receiving positional information of the sockets on the base;
determining a relative movement between a laser and a base plate;
emitting a laser beam from the laser to the base plate; and
producing a socket in the base plate by the emitted laser beam to form a dental base configured to receive the physical tooth models.

2. The method of claim 1, wherein the base plate comprises a material selected from one of the following: polymers, thermal elastic materials, urethane, epoxy, plaster, clay, acrylic, latex, dental PVS, resin, metal, aluminum, ice, wax, sand, and stone.

3. The method of claim 1, further comprising:
labeling the physical tooth models and their associated sockets on the base in a predetermined sequence to define the positions of the physical tooth models on the base.

4. The method of claim 1, further comprising:
generating positional information of the sockets on the base in accordance with a digital arch models that is acquired from a patient's arch.

5. The method of claim 1, wherein determining a relative movement between the laser and the base plate includes moving the base plate by a motorized stage in X and Y directions.

6. The method of claim 1, wherein determining relative movement between the laser and the base plate includes moving the base plate in a first direction and moving the laser beam in a second direction.

7. The method of claim 1, further comprising
focusing the emitted laser beam to a location on the base plate to produce the socket.

8. The method of claim 1, further comprising
guiding the emitted laser beam by an optical fiber to a location on the base plate to cut the socket.

9. The method of claim 1, wherein the material around the location on the base plate is removed by heating, melting, ablation, or evaporation by the emitted laser beam.

10. The method of claim 1, wherein the physical tooth models comprise features to assist the reception of the physical tooth models by the base.

11. The method of claim 10, wherein the features comprise one or more of a pin, a registration slot, a notch, a protrusion, a hole, an interlocking mechanism, a jig, and a pluggable or attachable feature.

12. The method of claim 10, wherein the features in the physical tooth models are shaped in accordance with the profile of the emitted laser beam that produces the socket in the base plate.

13. The method of claim 1, further comprising
producing a plurality of sockets in the base plate by the emitted laser beam to form a base to receive a plurality of physical tooth models to form a physical dental arch model.

14. The method of claim 11, wherein the base comprises a plurality of configurations of sockets, wherein each of the configurations is adapted to receive physical tooth models to form a different arrangement of a tooth arch model.

15. The method of claim 14, further comprising:
inserting the physical tooth models into the sockets in a first configuration; and
inserting the physical tooth models into the sockets in a second configuration.

16. A method for producing a dental base having sockets for receiving physical tooth models, comprising:
producing the physical tooth models having one or more of a pin, a protrusion, and a pluggable feature at the bottom portion;
determining a relative movement between a laser and a base plate;
emitting a laser beam from the laser to the base plate;
producing a socket in the base plate by the emitted laser beam; and
inserting the pin, the protrusion, or the pluggable feature at the bottom portion of the physical tooth models to the sockets in the base to form a physical dental arch model.

17. A system for producing a base for receiving physical tooth models, comprising:
a computer adapted to store positional information of the sockets to be formed on a base plate;
a transport system configured to move the base under the control of the computer; and
a laser configured to emit a laser beam onto the base plate to form a socket in the base plate after the base plate is moved to a position in accordance to the positional information stored in the computer.

18. The system of claim 17, wherein the positional information of the sockets are derived from a digital arch model.

19. The system of claim 17, wherein the transport system includes a motorized stage that can move the base plate in two dimensions.

20. The system of claim 17, wherein the physical models comprise one or more of a pin, a registration a notch, a protrusion, and a pluggable or attachable feature that can be received by the sockets in the base.
